(19) United States
(12) Patent Application Publication
(10) Pub. No.: US 2026/0167186 A1
(43) Pub. Date: Jun. 18, 2026

(54) POTENTIAL ACTION ALERT FOR PATH-SHARING

(71) Applicant: Toyota Motor Engineering & Manufacturing North America, Inc., Plano, TX (US)

(72) Inventors: Evan A. Vijithakumara, Frisco, TX (US); Derek S. Caveney, Plymouth, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/985,957

(22) Filed: Dec. 18, 2024

(51) Int. Cl. B60W 30/095; B60W 30/10; B60W 40/09; B60W 50/00; G01C 21/28; G08G 1/01

(52) U.S. Cl. CPC B60W 30/0953; B60W 30/10; B60W 40/09; G01C 21/28; G08G 1/0129; G08G 1/0141; B60W 50/0097; B60W 2420/40; B60W 2540/30; B60W 2556/50; B60W 2720/10; B60W 2720/24; B60W 2756/10

(57) ABSTRACT

Systems, methods, and other embodiments described herein relate to real-time path sharing. In one embodiment, a method includes acquiring data about a route and a current location of a vehicle. The method includes predicting a path of the vehicle according to the data. The method includes, responsive to determining the path satisfies an action threshold, generating a message about the path. The method includes communicating the message to a target area.

### TECHNICAL FIELD

The subject matter described herein relates, in general, to sharing path information between vehicles and, more particularly, to providing short-range communications specifying a predicted path to facilitate awareness by affected nearby vehicles in a limited target area.

### BACKGROUND

Challenges exist in driving where a following vehicle needs to anticipate the actions of the vehicle ahead, but the future intentions of the leading vehicle are often not readily determinable. This issue may be especially evident in complex driving scenarios, where the potential for unexpected maneuvers is high and can lead to unsafe conditions if not anticipated and acted upon in time. In real-world driving, especially in mixed-traffic environments with varying levels of automation, drivers often find themselves in situations where they need to anticipate the actions of vehicles ahead of them. For instance, a driver following a vehicle may want to know in advance whether the vehicle in front will suddenly change lanes, make an unexpected turn, or slow down. Such knowledge allows the following driver to adjust their driving behavior, reducing the risk of collisions and improving overall traffic flow. Conversely, a driver in the front vehicle (acting as ego vehicle in this example) may also be concerned about ensuring that the driver behind them is aware of their intentions, especially in situations where their actions may not be immediately apparent, such as when preparing to take an abrupt turn or merge onto another lane.

However, even when a driver and/or vehicle systems are able to observe a vehicle, predicting abrupt maneuvers can still escape their ability as the maneuvers generally do not follow common driving practices and thus are not often predictable. The driver and the vehicle systems generally lack the capability to infer the intentionality behind these movements, such as whether the vehicle ahead plans to turn left, merge into another lane, is out of position to exit a highway and is likely to take evasive actions, etc. This limitation creates uncertainty for the following driver, particularly in scenarios involving complex maneuvers, such as rapidly changing lanes or navigating multilane intersections, which could lead to collisions if not anticipated in time.

### SUMMARY

Example systems and methods relate to a manner of real-time path-sharing. As previously noted, anticipating abrupt or otherwise unexpected maneuvers of nearby vehicles is difficult and generally escapes the abilities of advanced driving assistance systems (ADAS) and drivers alike. That is, drivers are typically tasked with attempting to guess when another vehicle may act in an unexpected way to avoid dangerous circumstances. However, this is generally not feasible, and, thus, drivers may be caught off guard when another vehicle performs such a maneuver.

Therefore, in at least one approach, an inventive system aims to address this gap by enabling vehicles to share predicted trajectories of their movements with nearby vehicles within a limited, targeted area. This information transmission allows the nearby vehicle to receive information that can be extrapolated into an early warning about the anticipated maneuver of the ego vehicle, enabling the driver to adjust their approach accordingly. That is, the ego vehicle can predict a future path of the vehicle based on a known or inferred destination. Thus, when the ego vehicle is likely to make a turn, an abrupt lane change, etc., the system can anticipate the maneuver and communicate the maneuver to nearby vehicles. Moreover, in order to further simplify the approach, the system does not generally establish a connection with a nearby vehicle but instead defines a target area that is an area likely to be affected by the maneuver. For example, in the instance of an abrupt lane change, the system may identify the target area as an area to the rear passenger side of the vehicle that corresponds with the direction of the maneuver.

The system may then focus a transmission to the target area as a one-way broadcast transmission that does not require a pre-arranged/established connection. Accordingly, if a nearby vehicle is present in the area, the vehicle can receive the transmission and provide an alert or other action to reduce the safety risk of the potential maneuver. This approach is particularly valuable in situations where the vehicle's decision-making process is not immediately clear from external observations. For example, on multilane arterial roads, a vehicle may need to change lanes rapidly to complete an upcoming turn, creating potential conflicts with nearby vehicles. In such cases, early sharing of predicted intentions can help drivers adjust their positions or speeds to accommodate the upcoming maneuver, thereby improving safety. Similarly, in complex parking lot scenarios, where vehicles may need to navigate multiple lanes or conflicting entry points to access different store entrances, sharing trajectory predictions can help reduce confusion and prevent accidents. Additionally, drivers following slower vehicles may benefit from receiving trajectory predictions indicating whether the vehicle ahead is likely to turn left or right, switch lanes, or maintain its current path, enabling better decision-making and smoother traffic flow.

This approach is applicable across a wide range of driving contexts, including manual driving, assisted driving, and autonomous driving, and is designed to enhance safety, coordination, and overall driving experience in environments with high uncertainty and reactive vehicle inputs. By enabling vehicles to share predicted trajectories, this system provides a proactive solution to many common driving challenges, helping drivers navigate complex situations with greater confidence and safety.

In one embodiment, an action system is disclosed. The action system includes one or more processors and a memory communicably coupled to the one or more processors. The memory stores a control module including instructions that, when executed by the one or more processors, cause the one or more processors to acquire data about a route and a current location of a vehicle. The instructions include instructions to predict a path of the vehicle according to the data. The instructions include instructions to, responsive to determining the path satisfies an action threshold, generate a message about the path. The instructions include instructions to communicate the message to a target area.

In one embodiment, a non-transitory computer-readable medium including instructions that, when executed by one or more processors, cause the one or more processors to perform one or more functions is disclosed. The instructions include instructions to acquire data about a route and a current location of a vehicle. The instructions include instructions to predict a path of the vehicle according to the data. The instructions include instructions to, responsive to determining the path satisfies an action threshold, generate a message about the path. The instructions include instructions to communicate the message to a target area.

In one embodiment, a method is disclosed. In one embodiment, the method includes acquiring data about a route and a current location of a vehicle. The method includes predicting a path of the vehicle according to the data. The method includes responsive to determining the path satisfies an action threshold, generating a message about the path. The method includes communicating the message to a target area.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an action system associated with real-time path sharing for vehicles in a target area.

FIG. 3 illustrates a diagram of an action system within a cloud-computing environment.

FIG. 4 illustrates separate examples of target areas for directing a message.

FIG. 5 illustrates an example scenario in which the action system operates to provide alerts to nearby vehicles.

FIG. 6 is a flowchart illustrating one embodiment of predicting a vehicle path and sharing the predicted path within a target area proximate to the vehicle.

FIG. 7 is a flowchart illustrating one embodiment of providing information about a predicted path within a nearby vehicle that is traveling in a target area.

### DETAILED DESCRIPTION

Systems, methods, and other embodiments associated with real-time path sharing are disclosed. As previously noted, anticipating abrupt or otherwise unexpected maneuvers of nearby vehicles is difficult. That is, drivers are typically tasked with attempting to anticipate when another vehicle may act in an unexpected way to avoid dangerous circumstances. However, consistently anticipating correctly is generally not feasible, and, thus, drivers may be caught off guard when another vehicle performs such a maneuver.

Therefore, in at least one approach, an action system aims to address this gap by enabling vehicles to share predicted trajectories of their movements with nearby vehicles within a limited, targeted area. This information transmission allows the nearby vehicle to receive information that can be extrapolated into an early warning about the anticipated maneuver of the vehicle, enabling the driver to adjust their approach accordingly. That is, the vehicle can predict a future path based on a known or inferred destination. Accordingly, the system may leverage information from a navigation system or may learn through repeated patterns of a driver a likely destination of the vehicle.

As such, the system can then assess a current position against a route to determine likely maneuvers and, thus, the future trajectory of the vehicle. That is, the system attempts to anticipate when the vehicle is likely to make a turn, an abrupt lane change, etc., by generating a predicted trajectory according to at least the current position and the route as inferred or explicitly known. Moreover, in order to further simplify the approach, the system does not generally establish a connection with a nearby vehicle, but instead defines a target area that is likely to be affected by the predicted trajectory. For example, in the instance of an abrupt lane change, the system may identify the target area as an area to the rear passenger side (i.e., starboard) of the vehicle that corresponds with the direction of the maneuver. In the case of a U-turn, the system may identify the target area as being forward to the vehicle.

In any case, the system focuses a transmission to the target area as a one-way broadcast transmission that does not require a pre-arranged connection. Additionally, the system provides the transmission within the limited, targeted area by, for example, limiting transmission power and direction in order to avoid providing the transmission to vehicles that are unaffected. If a nearby vehicle is present in the area, the vehicle can receive the transmission and provide an alert or other action to facilitate avoiding the potential maneuver. For example, the nearby vehicle may alert the driver about the maneuver using an audible or visual alert generated within the vehicle. In this way, the system provides proactive assistance to many common driving challenges, helping drivers navigate complex situations with greater confidence and safety.

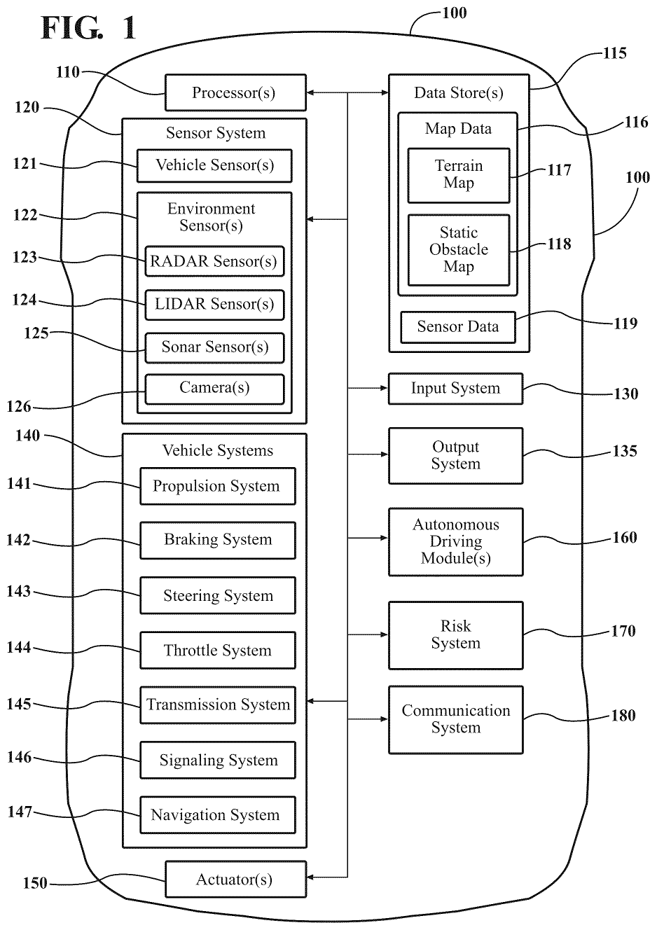

Referring to FIG. 1, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any device that, for example, transports passengers. In various approaches, the vehicle 100 may be an automated vehicle. The vehicle 100 may operate manually, autonomously, semi-autonomously, or with the assistance of various advanced driving assistance systems (ADAS). Further, the vehicle 100 may be a connected vehicle that is capable of communicating wirelessly with other devices, such as cloud-computing elements.

In any case, the vehicle 100 also includes various elements. It will be understood that, in various embodiments, it may not be necessary for the vehicle 100 to have all of the elements shown in FIG. 1. The vehicle 100 can have any combination of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, one or more components of the disclosed system can be implemented within the vehicle 100, while further components of the system are implemented within a cloud-based environment, as discussed further subsequently.

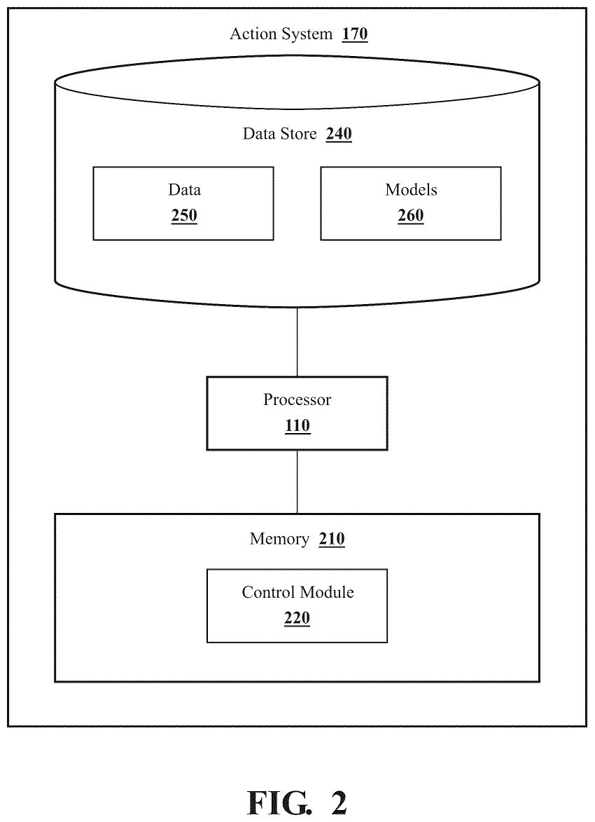

Some of the possible elements of the vehicle 100 are shown in FIG. 1 and will be described along with subsequent figures. However, a description of many of the elements in FIG. 1 will be provided after the discussion of FIGS. 2-7 for purposes of the brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the vehicle 100 includes an action system 170 that is implemented to perform methods and other functions as disclosed herein relating to predicting a trajectory and providing potential action alerts to nearby vehicles to facilitate improving the safety of the nearby vehicles.

Moreover, the action system 170, as provided for within the vehicle 100, functions in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a radio frequency (RF) communication protocol, such as a Wi-Fi, DSRC, V2I, V2V, or another suitable protocol for communicating between the vehicle 100 and other entities through direct signal transmission. Moreover, the communication system 180, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In one arrangement, the communication system 180 includes one or more phased-array antennae that function to direct transmission of electromagnetic waves in a specific direction without, for example, mechanically moving a direction in which the antennae are pointing. In any case, the action system 170 can leverage various wireless communication technologies and hardware elements to provide communications to other entities, such as nearby vehicles that may be traveling in a targeted area proximate to the vehicle 100.

With reference to FIG. 2, one embodiment of the action system 170 is further illustrated. The action system 170 is shown as including a processor 110 from the vehicle 100 of FIG. 1. Accordingly, the processor 110 may be a part of the action system 170, the action system 170 may include a separate processor from the processor 110 of the vehicle 100 or the action system 170 may access the processor 110 through a data bus or another communication path. In further aspects, the processor 110 is a cloud-based resource. Thus, the processor 110 may communicate with the action system 170 through a communication network or may be co-located with the action system 170. In one embodiment, the action system 170 includes a memory 210 that stores a control module 220. The memory 210 is a random-access memory (RAM), read-only memory (ROM), a hard-disk drive, a flash memory, or other suitable memory (either volatile or non-volatile) for storing the module 220 and/or other information used by the action system 170. The module 220 is, for example, computer-readable instructions within the physical memory 210 that, when executed by the processor 110, cause the processor 110 to perform the various functions disclosed herein.

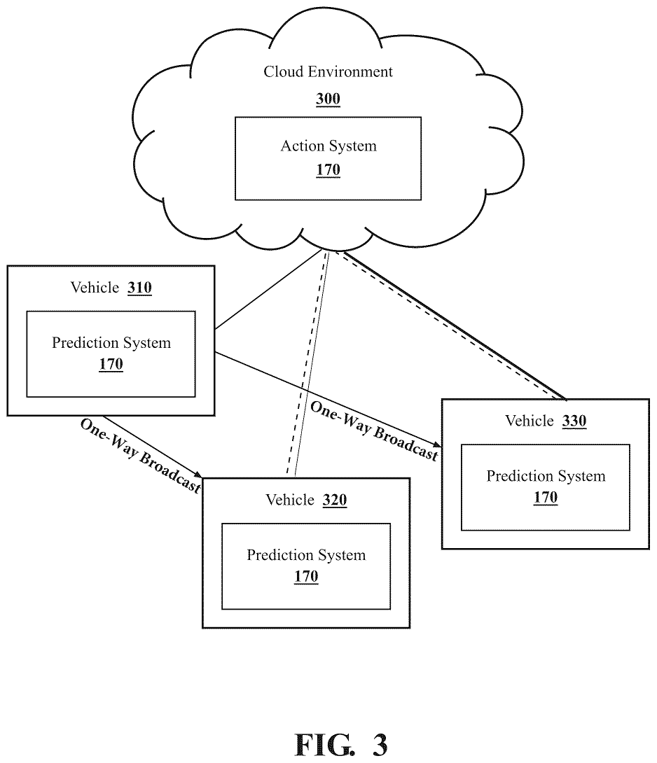

As previously noted, the action system 170 may be further implemented within the vehicle 100 as part of a cloud-based system that functions within a cloud environment 300, as illustrated in relation to FIG. 3. That is, for example, the action system 170 may be embodied as a vehicle-based instance and a cloud-based instance. In this arrangement, the vehicle-based instance may provide information to the cloud-based instance for different tasks. For example, the cloud-based instance may process offloaded data for the vehicle-based instance, the vehicle-based instance may report routes, trajectories, and other information to the cloud-based instance, and so on. In general, the cloud-based instance does not function to communicate trajectories to nearby vehicles, but can facilitate the learning of driving routes for the vehicle to assist with inferring routes and predicting trajectories. Accordingly, as shown, the action system 170 may include separate instances within one or more entities of the cloud-based environment 300, such as servers, and also instances within vehicles 310, 320, and 330 that function to acquire, analyze, and distribute the noted information. Moreover, FIG. 3 also illustrates one example of how the action system 170 can communicate with the cloud-based instance while also providing one-way broadcast communications to nearby vehicles. As shown, the vehicle 310 is transmitting a one-way broadcast to nearby vehicles 320 and 330. As will be explained in greater detail subsequently, the vehicles 310-330 need not have any pre-established relationship or connection. The inclusion within the same cloud-environment 300 is shown simply for purposes of explanation and should not be construed as implying any pre-established link/connection. In any case, the action system 170 of the vehicle 310 can provide the one-way broadcast as a potential action alert to the vehicles 320 and 330 to inform the vehicles 320 and 330 about potential future maneuvers of the vehicle 310, thereby improving safety.

Continuing with FIG. 2 and a general embodiment of the action system 170, in one or more arrangements, the action system 170 includes a data store 240. The data store 240 is, in one embodiment, an electronic data structure (e.g., a database) stored in the memory 210 or another electronic memory and that is configured with routines that can be executed by the processor 110 for analyzing stored data, providing stored data, organizing stored data, and so on. Thus, in one embodiment, the data store 240 stores data used by the module 220 in executing various functions. In one embodiment, the data store 240 includes the data 250, one or more models 260, and/or other information that is used by the control module 220. It should be appreciated that while the data store 240 is shown as including the data 250, and the models 260 separate instances of the action system 170 may implement the data store 240 to include different sets of information.

In any case, the control module 220 includes instructions that function to control the processor 110 to acquire the data 250. The data 250 can include information about the vehicle 100 itself and information about a surrounding environment of the vehicle 100. Thus, in at least one approach, the action system 170 captures observations of the surrounding environment in the form of the sensor data that the action system 170 receives. Depending on the particular implementation, the data 250 may vary in form. However, it should be appreciated that the data 250 includes at least location information about the current location of the vehicle 100 (e.g., GNSS data) along with, in at least one arrangement, route information that may be explicit or inferred. Of course, in further arrangements, the data 250 may include additional information, such as camera images, or other sensor data that facilitates determining the current location and lane position on a roadway along with, for example, other aspects of the surrounding environment.

Accordingly, the control module 220 generally includes instructions that cause the processor 110 to control one or more sensors of the vehicle 100 to generate observations about the surrounding environment. The control module 220, in one embodiment, controls respective sensors of the vehicle 100 to provide sensor data. The control module 220 may further process the sensor data into separate observations of the surrounding environment. For example, the control module 220, in one approach, fuses data from separate sensors to provide an observation about a particular aspect of the surrounding environment. By way of example, the sensor data 250 itself, in one or more approaches, may take the form of separate camera images, ultrasonic returns, radar returns, LiDAR returns, satellite-based location data (e.g., GNSS), and/or other information.

The control module 220 may derive determinations (e.g., location, pose, characteristics, etc.) from the sensor data and fuse the data for separately identified aspects of the surrounding environment, such as lane lines and so on. The control module 220 may further extrapolate the data into an observation by, for example, correlating the separate instances into a meaningful observation about an object beyond an instantaneous data point. In one arrangement, the control module 220 applies one of the models 260 to images in the sensor data to extract features representing objects and other features of the surrounding environment. In a similar manner, the control module 220 can process other types of data (e.g., radar, LiDAR, etc.) into features and then merge the features together that represent the same elements.

Additionally, while the control module 220 is discussed as controlling the various sensors to provide the sensor data, in one or more embodiments, the module 220 can employ other techniques that are either active or passive to acquire the sensor data. For example, the control module 220 may passively sniff the sensor data from a stream of electronic information provided by the various sensors or other modules/systems in the vehicle 100 to further components within the vehicle 100. Moreover, the sensor data may include information about the vehicle 100 itself, such as a location, a speed, acceleration, heading, steering angle, passengers present, and so on. Thus, the sensor data, in one embodiment, represents a combination of perceptions acquired from multiple sensors.

Of course, depending on the sensors that the vehicle 100 or another entity includes, the available sensor data that the action system 170 can acquire may vary. As one example, according to a particular implementation, the vehicle 100 may include different types of cameras or placements of multiple cameras. When acquiring the sensor data, the control module 220 may acquire various electronic inputs that originate from the vehicle 100, which may be stored in the data store 240 of the action system 170 as the data 250 and processed according to various algorithms, such as machine learning algorithms, heuristics, and so on.

Moreover, as briefly noted, the data 250 includes information about a current route of the vehicle 100. In one example, the route information may be explicit. That is, a driver may input an explicit destination into a navigation system or into a mobile device within the vehicle 100. The navigation system then generates an explicit route of how to proceed from a current location to the destination that, in at least one arrangement, maps specific roads and turns to reach the destination. The control module 220 can then acquire the route information from the navigation system of the vehicle 100 or mobile phone. The route information informs the control module 220 of likely maneuvers that the driver will execute along the route.

Similarly, when explicit route information is not available, the control module 220 may acquire the route information according to an inferred destination. In at least one configuration, the control module 220 can learn patterns in routes taken by the driver from which the control module 220 is then able to infer a current destination. By way of example, the control module 220 can log routes according to time of day, day of week, etc. In general, most drivers drive the same routes when going to work, picking up children, running errands, etc. These routes tend to follow patterns in the time of day and day of the week. The user may further make similar stops along the routes, such as stopping for morning coffee at the same place when going to work. Accordingly, the control module 220 can log this information and may train one of the models 260 to infer the route according to current contextual clues, such as time, day, passengers present in the vehicle 100, etc. As a result, the model, which is generally a machine-learning model, outputs a destination and/or multiple destinations that may occur in sequence. The control module 220 is then able to generate a route for the inferred destination that can be subsequently used to predict maneuvers. Accordingly, in addition to sensor data, the data 250 can further include the route information that is either inferred or explicit.

The control module 220 then uses the data 250 to predict a path of the vehicle 100. In at least one arrangement, the control module 220 applies one of the models 260 to the data 250 to predict the path. It should be noted that the data 250, as either part of the route information or independently, includes knowledge of the road. That is, the route information includes a structure of the road indicating road types, posted speeds, lanes, junctions, traffic signals, and so on so that the model can consider various aspects that influence control of the vehicle 100.

In any case, the control module 220 predicts the path of the vehicle 100 out to a prediction horizon (e.g., 5.0 s) and in relation to a current location/position on the roadway relative to the route. The prediction horizon may be increased or decreased in control module 220 based on vehicle, route, and other signal inputs. In general, the predicted path is a trajectory of the vehicle 100 for the defined prediction horizon. Thus, the predicted path defines a trajectory (i.e., heading and speed) of the vehicle for multiple instances (e.g., every 0.1 s) over the prediction horizon. By way of example, consider that the vehicle 100 is traveling on a multilane roadway on a lane that is farthest from a turn/exit lane. Further consider that 160 m ahead is the exit for the vehicle 100 to follow the route. The danger in this instance is that the driver may attempt an emergency lane change across multiple lanes in order to correct being inadvertently out of position and to make the turn, even though doing so may not be anticipated by surrounding traffic. That is, changing lanes in this way could potentially impact nearby vehicles within the adjacent lanes through which the vehicle 100 abruptly maneuvers to still make the exit/turn. Thus, the control module 220 predicts the path according to at least the current lane-level position and the route information.

Once the control module 220 generates the predicted path, the control module 220, in at least one arrangement, can proceed with further determining whether or not to generate a message (potential action alert) about the predicted path that is transmitted to nearby vehicles. The action system 170 selectively provides the message in order to avoid saturating nearby vehicles with communications that may be extraneous. Instead, the control module 220 determines when the messages about the predicted path are relevant to the operation of the nearby vehicles and then communicates the messages. To achieve this, the control module 220 may assess the predicted path, whether nearby vehicles are actually present, and/or other factors. In at least one arrangement, the control module 220 assesses the predicted path in relation to an action threshold. The action threshold defines, for example, different occurrences that constitute circumstances for communicating the message. The occurrences can include a sudden input to control the vehicle to correct the vehicle being out of position for the route, an abrupt alteration of speed, an abrupt turn of the vehicle, and so on. Overall, the action threshold defines any instance in which a future maneuver (i.e., the predicted path) is likely to influence the operation of at least one nearby vehicle as constituting a sufficient occurrence to communicate the message.

In various approaches, the action system 170 may define the action threshold and how the predicted path satisfies (i.e., meets) the action threshold differently. For example, in one approach, whenever the predicted path is determined to have characteristics that may influence the operation of a nearby other vehicle, the control module 220 determines that the predicted path meets the action threshold. The action system 170 can broadly define what it means to influence the operation of a nearby vehicle. For example, in a case where the control module 220 does not consider the explicit presence of nearby vehicles, the action system 170 may define influencing operation of the nearby vehicle as any change in operation from a steady state. Thus, by way of example, when the vehicle 100 changes speed or direction, in at least one approach, the control module 220 may consider the action threshold to be satisfied. In further examples, the control module 220 may set thresholds on, for example, a deceleration rate, a turn rate, etc. In yet further examples, the control module 220 may define the action threshold with additional elements, such as a turn rate for signaled versus unsignaled turns, lane changes that are signaled versus unsignaled, deceleration rates that are specific to different speeds or types of roadways (e.g., highway versus residential; high rates of speed versus lower rates of speeds), and so on.

In yet further approaches, the action system 170 determines whether the predicted trajectory satisfies the action threshold according to a target area and whether a nearby vehicle is present within or at least proximate to the target area. The target area is an area proximate to the vehicle 100 that is likely to be affected by the predict path. That is, the target area is an area within which the vehicle 100 may move or pass closely by if following the predicted path. Thus, a nearby vehicle that is present in the target area is likely to be at risk of a collision with the vehicle 100 or at least be impeded by the vehicle 100. Accordingly, the control module 220 determines the target area based on the predicted path. The target area is specific to the predicted path as the predicted motion of the vehicle 100 is generally the basis for defining the target area. As such, the control module 220 analyzes the predicted path to determine a likely direction of movement and then defines the target area according to the likely direction of movement relative to the vehicle 100.

Of course, while the control module 220 may implement the determination of the target area as a heuristic-based approach, in further examples, the control module 220 can use one of the models 260 that is trained to identify the target area. In at least one approach, the control module 220 may train the path prediction model that generates the predicted path to also output the target area, while in other examples the target area determination may be performed by a separate model. In any case, such a model can accept the predicted path along with information about the surrounding environment (e.g., a lane-level map) to identify the target area. In further approaches, the model may also accept vehicle characteristics (e.g., size) and/or other relevant information in order to generate the target area as an output. The target area itself can be defined differently depending on the implementation. That is, the shape and size of the target area may vary depending on the implementation. The control module 220 may generate the target area as a polygon (e.g., rectangle), a wedge, a circle, and so on. The size of the target area may vary depending on the implementation as well. In one approach, the size of the target area is, for example, a predefine size (e.g., three times a length of the vehicle 100), while in other arrangements, the control module 220 dynamically determines the size according to current dynamics (e.g., speed) and/or environment conditions (e.g., weather). Whichever approach is undertaken, the action system 170 can generate the target area to facilitate defining an area that is potentially impacted by the predicted path.

Accordingly, with continued reference to the determination of whether the predicted path satisfies the action threshold, the control module 220 can use the target area to determine whether the action threshold is satisfied or not. In this instance, the control module 220 may actively determine whether or not a nearby vehicle is present within or at least proximate to the target area. For example, the control module 220 can collect sensor data from one or more sensors that permit the control module 220 to determine a location of nearby vehicles relative to the vehicle 100. The control module 220 can use, for example, images, ultrasonic returns, radar returns, LiDAR returns, and so on to identify and localize nearby vehicles. In this case, the control module 220 determines whether a detected nearby vehicle is within or at least proximate to (e.g., within a threshold distance 20 m) the target area. As such, when the control module 220 determines that the nearby vehicle is detected in or proximate to the target area, then the control module proceeds with generating and communicating a message.

The control module 220 generates the message to include information that is sufficient to inform the nearby vehicle(s) of the identity of the vehicle 100 and about the predicted path. Thus, the control module 220 can generate the message to specify a location of the vehicle 100 (e.g., lane position), a make/model, a color, a license plate number, etc. In general, the identifying information provided in the message is intended to be adequate for a driver of the nearby vehicle to easily determine which vehicle communicates the message and the potential action that may be taken by the vehicle. As such, to communicate about the potential action itself, the control module 220 can include a plain description of the predicted path or an associated action being taken by the driver.

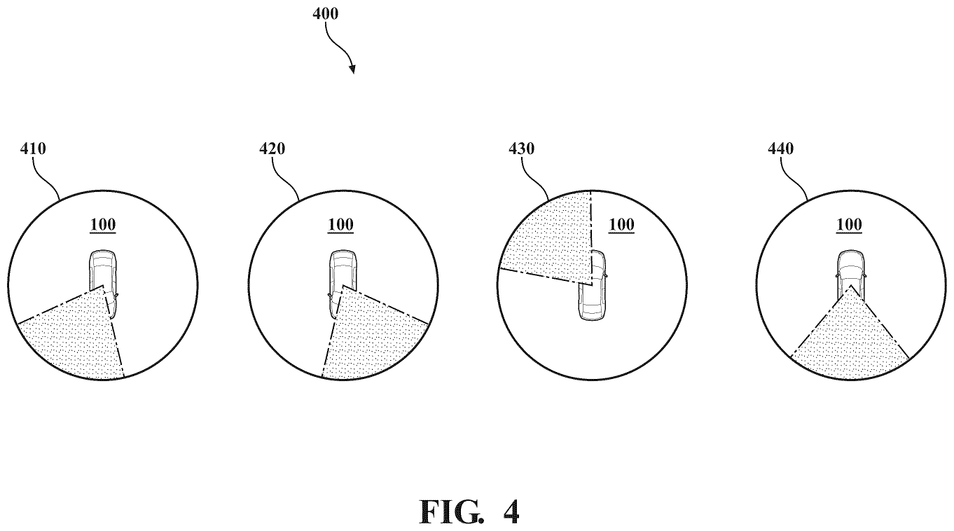

By way of example, consider FIG. 4, which illustrates diagrams 400 of target areas associated with different predicted trajectories. As shown, the target area 410 is to a rear port side (e.g., driver's side) of the vehicle 100 and is associated with the predicted path indicating a sudden left turn of the vehicle 100. In this example, the information about the path/risk may include “sudden left,” “left lane change,” or another similar indicator that describes the predicted path. The target area 420 is to a rear starboard side (e.g., passenger's side) of the vehicle 100 and is associated with the predicted path indicating a sudden right turn or lane change to the right. In this instance, the information about the path may specify “sudden right,” “right lane change,” etc. The target area 430 is to a forward port side of the vehicle 100 and is associated with the predicted path indicating a U-turn. For the target area 430, the message may specify “U-turn,” “left U-turn,” etc. The target area 440 is to a rear area of the vehicle 100 and is associated with the predicted path indicating a deceleration or exit from a current roadway. Thus, the message may specify “abrupt slow down,” “strong deceleration,” “exiting roadway,” etc.

In still further examples, the control module 220 may communicate the predicted trajectory itself as the information about the maneuver that may be performed by the vehicle 100, which can then be interpreted by the nearby vehicle. Moreover, while the determination of the target area has been described in relation to the assessment of the action threshold, it should be appreciated that in the case where the vehicle 100 does not consider the presence of other vehicles, the control module 220 may instead determine the target area when, for example, generating the message.

In any case, once the message is generated, the control module 220 transmits the message. The transmission is implemented, in one or more arrangements, as a one-way broadcast communication. That is, the vehicle 100 does not generally pre-establish a negotiated connection with the nearby vehicle(s). Instead, the control module 220 transmits the message blindly without consideration to the establishment of a formal connection and, in at least one arrangement, without knowledge of the actual presence of any nearby vehicles. By transmitting the message in this way, the action system 170 is able to simplify the implementation, thereby permitting the action system 170 to be implemented in a wider range of existing configurations of vehicles without requiring particular hardware.

Additionally, the control module 220, in at least one approach, may focus the transmission so as to avoid reception by unaffected vehicles. For example, the control module 220 may transmit the message in an omnidirectional or directed manner. In the case of being omnidirectional, the control module 220 may modulate the transmission power to adapt the signal strength and limit the distance to which the message is communicated. In general, the control module 220 considers the target when determining how to transmit the message. That is, the control module 220 determines the target area to define a distance and, in one approach, a direction in which the message is to be transmitted. Accordingly, the control module 220 can limit the signal strength to reduce the distance the message is transmitted but while ensuring the target area remains within an overall envelope of transmission. Moreover, as noted, the control module 220 can further direct the transmission in a particular direction using beamforming. Thus, the control module 220 can control a direction and/or a distance for transmitting the message in order to focus the transmission to nearby vehicles that may be affected by the predicted path.

To focus the transmission, the control module 220 defines the target area and derives the direction and distance based on the target area. The determination of a general direction of the target area has been described, but the overall footprint may be determined according to different approaches. For example, the control module 220 may define the target area as a wedge, a circle, or a polygon, depending on the implementation. The control module 220 then selects the transmission power and/or the direction to ensure the target area is included within the transmission footprint. In a case where the transmission footprint covers areas that are beyond the target area, the control module 220 may further include defining information about the target area within the message. That is, the control module may define a coordinate of a center point for a target area defined by a circular area. The center point, in combination with a radius, can be omnidirectionally transmitted with the message and the receiving nearby vehicles can then compute whether they are within the target area or not when determining to provide the message. The control module 220 may alternatively define the target area as a single point for indicating a perpendicular direction extending away from the vehicle that defines a rectangular area, two points that define a specific rectangular area associated with specific lanes, or three or more points to define a complex polygon. In any case, the control module 220 is able to transmit the message as a one-way broadcast communication so that the nearby vehicles can acquire information about the control of the vehicle 100 and avoid potentially risky maneuvers that are otherwise not predictable by an external observer.

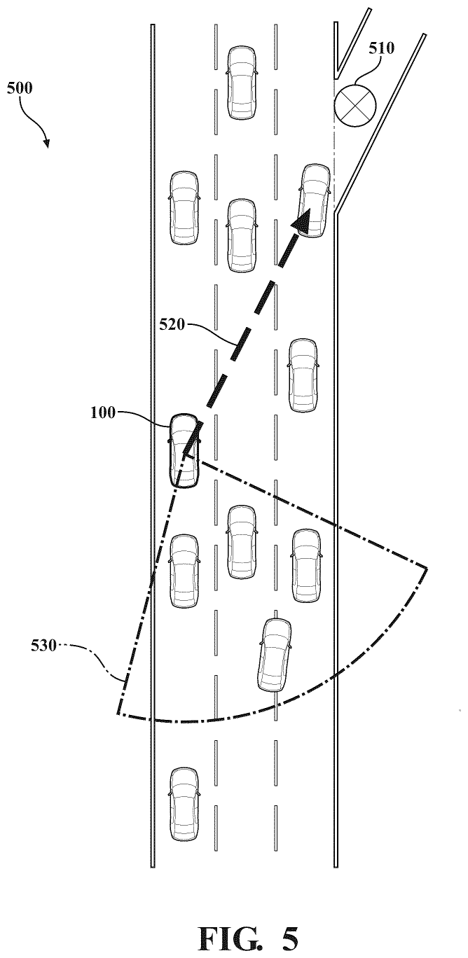

As one example scenario of how the action system 170 may operate, consider FIG. 5, which illustrates a diagram 500 of a multilane roadway with multiple vehicles and an exit ramp. As illustrated, the vehicle 100 is traveling in a left-most lane of the roadway. Accordingly, consider that the vehicle 100 is following a route that requires the vehicle 100 to exit via an exit ramp shown via a waypoint 510. Thus, the action system 170 determines the current location of the vehicle 100 and the route information that specifies the waypoint 510. As a result, the action system 170 indicates a predicted path 520 that shows the vehicle 100 making a rapid series of lane changes in order to maintain the route. The action system 170 considers the predicted path in relation to the action threshold and determines that the predicted path satisfies the action threshold because, for example, the turn rate of the vehicle exceeds a defined operating threshold. Alternatively, the action system 170 may identify the rapid series of lane changes required to maintain the predicted path alone as satisfying the action threshold. In any case, the action system 170 determines a target area 530 based on the predicted path 520 and generates the message to indicate that the vehicle 100 may make an abrupt lane change to the right to exit the roadway.

The action system 170 then transmits the message by directing the transmission into the target area using beamforming and by limiting the transmission power. This permits the message to be received by the nearby vehicles within the target area while limiting other vehicles from receiving the message and potentially confusing those vehicles about the proximate risk. Once received, the nearby vehicles can then present an alert, such as “Caution: The purple vehicle in the left-most lane may exit suddenly to the right,” which is derived from the description provided in the message. In this way, the action system 170 is able to provide an alert to nearby vehicles in order to improve the awareness of drivers about evasive or otherwise unpredictable maneuvers of the vehicle 100, thereby improving safety.

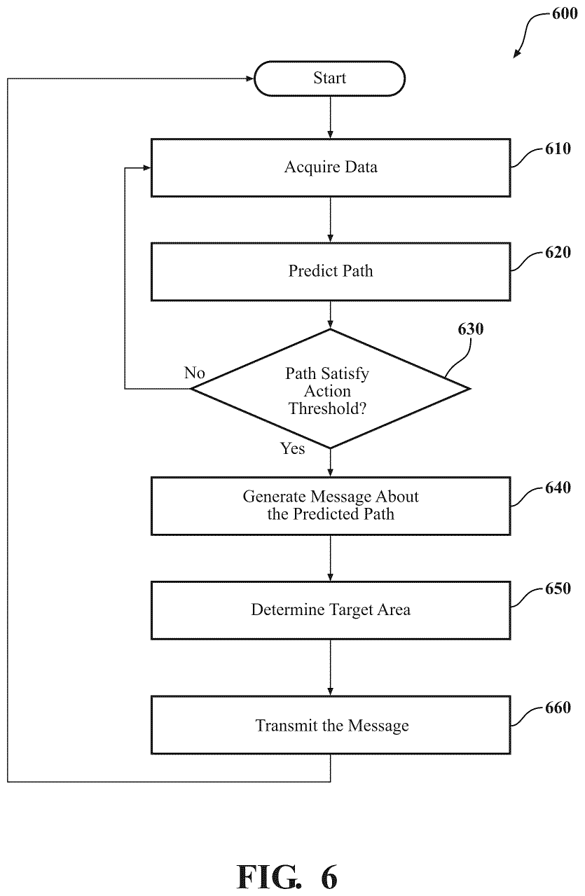

Additional aspects about sharing path information between vehicles will be described in relation to FIG. 6. FIG. 6 illustrates a flowchart of a method 600 that is associated with predicting a path of a vehicle and selectively sharing the path with nearby vehicles. Method 600 will be discussed from the perspective of the action system 170 of FIGS. 1-2. While method 600 is discussed in combination with the action system 170, it should be appreciated that the method 600 is not limited to being implemented within the action system 170 but is instead one example of a system that may implement the method 600. Furthermore, while the method is illustrated as a generally serial process, various aspects of the method 600 can execute in parallel to perform the noted functions.

At 610, the control module 220 acquires the data 250. As outlined previously, the data 250 includes at least information about a route of the vehicle 100 a current location of the vehicle 100. Thus, the data 250 may include sensor data from the vehicle 100 and/or other devices (e.g., roadside units, connected vehicles, etc.) and route information that is either explicit or inferred. Accordingly, the control module 220 may control the sensor system 120 to acquire the sensor data. In one embodiment, the control module 220 controls the camera 126 of the vehicle 100 to observe the surrounding environment. Alternatively, or additionally, the control module 220 controls the camera 126 and the LiDAR 124 or another set of sensors to acquire the sensor data. As part of controlling the sensors to acquire the sensor data, it is generally understood that the sensors acquire the sensor data of a region around the vehicle 100 with data acquired from different types of sensors generally overlapping in order to provide for a comprehensive sampling of the surrounding environment at each time step. Thus, the control module 220, in one embodiment, controls the sensors to acquire the sensor data of the surrounding environment.

Moreover, in further embodiments, the control module 220 controls the sensors to acquire the sensor data 250 at successive iterations or time steps. Thus, the action system 170, in one embodiment, iteratively executes the functions discussed at blocks 610-630 to acquire the data 250 and provide information therefrom. Furthermore, the control module 220, in one embodiment, executes one or more of the noted functions in parallel for separate observations in order to maintain updated perceptions. Additionally, as previously noted, the control module 220, when acquiring data from multiple sensors, may fuse the data together to form the sensor data and to provide for improved determinations of detection, location, and so on.

As an additional aspect of acquiring the data 250, the control module 220 further determines the route information. The route information may be either explicit or inferred. That is, when an explicit destination is available from a navigation system of the vehicle 100 or another source, then the control module 220 knows the destination and the route that the driver is following. However, when there is no explicit destination available, the control module 220 infers the destination and associated route according to learned behaviors of the driver. As such, the control module 220 leverages a driving history for the particular driver in order to infer the route plan (i.e., destination and route to reach the destination). As noted previously, the control module 220 identifies patterns of the driver according to prior routes driven by the driver in order to assess the likely current destination and route that the driver will follow. It should be noted that the route taken by the driver may not be the same as what would be determined by a navigation system as the driver may follow preferred roads or stop at intermediate destinations. Thus, the control module 220 can learn these tendencies and provide the inferred destination when an explicit destination is not available.

At 620, the control module 220 predicts a path of the vehicle 100 according to the data 250. In general, predicting the path includes determining a future maneuver of the vehicle that is associated with the route of the vehicle in relation to a current location (e.g., lane position on a roadway). The path prediction is an attempt to identify a type of the future maneuver, which may be a nominal maneuver that is not likely to affect any nearby vehicles (e.g., maintaining a current trajectory) or an unexpected maneuver that is, for example, abrupt or otherwise a change in the trajectory that is not generally determinable from the observed behavior of the vehicle 100. Accordingly, by applying a prediction model of the models 260 to the data 250, the control module 220 is able to generate a prediction of the future movement of the vehicle 100 out to a defined prediction horizon (e.g., 5.0 s). The prediction horizon may be increased or decreased in control module 220 based on vehicle, route, and other signal inputs. It should be noted that the path itself generally defines a trajectory of the vehicle 100 (i.e., heading, acceleration, and speed) at separate iterations over the prediction horizon. Of course, in alternative arrangements, the control module 220 may generate the path as a simplified trajectory that indicates an overall expected direction of travel of the vehicle 100 (e.g., a heading alone).

At 630, the control module 220 determines whether the path satisfies an action threshold. The control module 220 may determine whether the path satisfies the action threshold in multiple ways depending on the implementation. As outlined previously, the control module 220 may consider the presence of nearby vehicles relative to a target area and characteristics of the path or the control module 220 may consider the predicted path in comparison to the action threshold alone. In both cases, the control module 220 assesses a general nature of the predicted path to determine, for example, whether the future maneuver is likely to influence operation of at least one nearby vehicle. This may entail determining specific actions, such as whether the future maneuver involves a sudden input to control the vehicle 100 to correct being out of position for the route, an abrupt alteration of speed, an abrupt turn of the vehicle, etc. In general, the action threshold may define acceleration rates and turn rates beyond which the maneuver is considered to be a risk. When the control module 220 determines that the path does satisfy the action threshold, then the control module 220 proceeds with generating the message at 640. Otherwise, the control module 220 continues to monitor the path in relation to the action threshold via 610-630.

At 640, the control module 220 generates a message about the path. The message includes, for example, identifying information about the vehicle 100 and also information about the future maneuver (i.e., the path). In further arrangements, the message may also include information defining a target area so that the receiving vehicles can determine a relevancy of the message. The identifying information is, in at least one approach, descriptive information about the vehicle that relates to an appearance of the vehicle 100 and/or a location of the vehicle on the roadway. For example, the descriptive information may specify a color, a make/model, a license plate number, or other identifying information. The location may be a relative location on the roadway that is defined in relation to the nearby vehicles of the target area. For example, the location information may specify that the vehicle 100 is ahead, to the left/right, in a particular lane, and so on.

The information about the path may include a simple indication about an overall nature of the path (e.g., abrupt movement toward the right) or more specific information (e.g., abrupt multiple lane change to an exit). In yet a further approach, the information about the path can include the path itself so that the nearby vehicle can interpret the information specifically in relation to that vehicle and according to preferences of that driver. Moreover, as noted, the message may also include, in at least one arrangement, coordinates for a target area. It should be appreciated that, in general, the target area information is provided in instances when the vehicle 100 is not performing beamforming so that the nearby vehicles can determine an affected location. In any case, the control module 220 may include different coordinates depending on the particular shape/size of the target area implemented by the action system 170. The coordinates may define a center point and a radius when the target area is circular, a single point for indicating a perpendicular direction extending away from the vehicle that defines a rectangular area, two points that define a specific rectangular area associated with specific lanes, or three or more points to define a complex polygon. In this way, the vehicle 100 is able to communicate additional information to the nearby vehicles to facilitate focusing the message.

At 650, the control module 220 determines the target area associated with the path. It should be noted that the determination at 650 may occur in parallel with other determinations in the method 600 and is not limited to the noted sequence. Accordingly, the control module 220 identifies, in at least one configuration, a region proximate to the vehicle 100. The control module 220 defines the region according to whether the path of the vehicle 100 would likely influence operation of another vehicle within that space. Thus, the vehicle 100 need not travel through the target area, but rather the control module 220 determines whether the path of the vehicle 100 would cause another vehicle operating in that space to adjust operation in order to, for example avoid a collision, maintain a safe operating distance, and so on. In at least one approach, the control module 220 generates the target area using a model, such as the same model that determines the path.

At 660, the control module 220 communicates the message to the target area. The control module 220 communicates the message by, in at least one approach, transmitting the message wirelessly using a transmitter of the vehicle 100. The particular protocol that the action system 170 uses may vary but the intent is to provide a one-way broadcast communication that does not require a pre-established relationship between the vehicles. Additionally, communicating the message may be irrespective of whether other vehicles are actually present in the target area. That is, the action system 170 may be blind to the presence of other vehicles and simply provides the message as a safety/risk alert to facilitate the operation of other vehicles while not requiring additional technology on the vehicle 100 to sense the presence of the other vehicles.

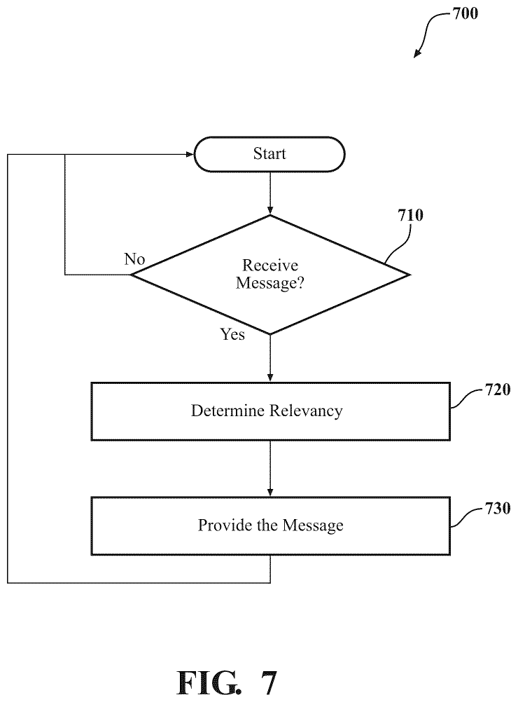

Moreover, the transmission may be of a fixed or variable signal strength and the direction may also be fixed or variable depending on the implementation. In the instance of focusing the transmission at the target area, the control module 220 may use a transceiver to adjust power settings and/or beamforming technology to direct the transmission at the target area. In this way, the action system 170 is able to provide information to the nearby vehicles to improve safety. FIG. 7 illustrates a flowchart of a method 700 that is associated with receiving and providing a potential action alert message within a nearby vehicle. Method 700 will be discussed from the perspective of the action system 170 of FIGS. 1-3. While method 700 is discussed in combination with the action system 170, it should be appreciated that the method 700 is not limited to being implemented within the action system 170 but is instead one example of a system that may implement the method 700. Furthermore, while the method is illustrated as a generally serial process, various aspects of the method 700 can execute in parallel to perform the noted functions. As an initial note, the action system 170 may be implemented as separate instances within separate vehicles. In relation to the context of the nearby vehicles, the nearby vehicles may implement fully capable instances of the action system 170 that can both generate/transmit messages and receive messages or may simply implement instances for receiving and providing the messages within the vehicle 100 according to method 700.

At 710, the action system 170 monitors for a transmission that includes a message. In various approaches, the action system 170 may monitor for a signal on a particular wireless channel, an identifier or flag within a received communication, etc. Upon detecting the reception of a message, the action system 170 transitions to processing the message, as described at 720.

At 720, the action system 170 determines the relevancy of the message. Determining the relevancy may include multiple different aspects depending on the implementation. For example, the action system 170 may determine if the message is actually directed at the vehicle that has received the message. In further aspects, determining the relevancy may involve validating the message as a security measure. In the case of determining if the message is directed to the vehicle that has received the message, the action system 170 may decode a target area specified within the message and determine if a location of the vehicle is within a footprint of the target area. In yet a further approach, the vehicle may perform active perception itself to identify the vehicle 100 from the description or coordinates provided in the message. In yet another approach, the vehicle may simply assume that since it received the message, the message is directed to the receiving vehicle. If the vehicle is not able to determine the message is relevant in the noted instances, then the vehicle may disregard the message and continue monitoring for a subsequent message.

In regards to validating the message, the action system 170 may validate a certificate according to an encrypted signature, validate a security ID included in the message, or perform another security measure to ensure that the message is authentic. If the message cannot be authenticated, then the vehicle may return to monitoring for a message without providing the message.

At 730, the action system 170 provides the message. The action system 170 may provide the message in different ways depending on the implementation. For example, in one approach, the action system 170 provides the message as an audible alert. The audible alert may be a simple beep or other noise that raises the awareness of the driver about the potential of a safety hazard. In further approaches, the alert may be a verbal alert that specifies the identity of the vehicle 100 and the action the vehicle 100 may take. In still further approaches, the action system 170 may provide the message as a visual alert on an in-vehicle display or through an augmented reality (AR) display that overlays the warning on the actual vehicle 100 from a viewpoint of the driver. The action system 170 may also use a combination of the noted approaches for providing the message. In this way, the action system 170 is able to improve the awareness of the driver, thereby improving the safety of the nearby vehicle.

FIG. 1 will now be discussed in full detail as an example environment within which the system and methods disclosed herein may operate. In some instances, the vehicle 100 is configured to switch selectively between an autonomous mode, one or more semi-autonomous operational modes, and/or a manual mode. Of course, in further aspects, the vehicle 100 may be a manually driven vehicle that may or may not include one or more driving assistance systems, such as active cruise control, lane-keeping assistance, crash avoidance, and so on. In any case, “manual mode” means that all of or a majority of the navigation and/or maneuvering of the vehicle is performed according to inputs received from a user (e.g., human driver). In one or more arrangements, the vehicle 100 can be a conventional vehicle that is configured to operate in only a manual mode.

In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU). The vehicle 100 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills, etc. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the vehicle 100 (including any of the elements shown in FIG. 1). The sensor system 120 can acquire data of at least a portion of the external environment of the vehicle 100 (e.g., nearby vehicles).

The sensor system 120 can include various types of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the vehicle 100. In one or more arrangements, the vehicle sensor(s) 121 can include a speedometer to determine a current speed of the vehicle 100.

Alternatively, or in addition, the sensor system 120 can include one or more environment sensors 122 configured to acquire, and/or sense driving environment data. “Driving environment data” includes data or information about the external environment in which an autonomous vehicle is located or one or more portions thereof. For example, the one or more environment sensors 122 can be configured to detect, quantify and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify and/or sense other things in the external environment of the vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include an input system 130. An “input system” includes any device, component, system, element, or arrangement or groups thereof that enable information/data to be entered into a machine. The input system 130 can receive an input from a vehicle passenger (e.g., a driver or a passenger). The vehicle 100 can include an output system 135. An “output system” includes any device, component, or arrangement or groups thereof that enable information/data to be presented to a vehicle passenger (e.g., a person, a vehicle passenger, etc.).

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the action system 170, and/or the automated driving module(s) 160 can be operatively connected to communicate with the various vehicle systems 140 and/or individual components thereof. For example, returning to FIG. 1, the processor(s) 110 and/or the automated driving module(s) 160 can be in communication to send and/or receive information from the various vehicle systems 140 to control the movement, speed, maneuvering, heading, direction, etc. of the vehicle 100. The processor(s) 110, and/or the automated driving module(s) 160 may control some or all of these vehicle systems 140 and, thus, may be partially or fully autonomous.

The processor(s) 110, and/or the automated driving module(s) 160 can be operatively connected to communicate with the various vehicle systems 140 and/or individual components thereof. For example, returning to FIG. 1, the processor(s) 110, the action system 170, and/or the automated driving module(s) 160 can be in communication to send and/or receive information from the various vehicle systems 140 to control the movement, speed, maneuvering, heading, direction, etc. of the vehicle 100. The processor(s) 110, the action system 170, and/or the automated driving module(s) 160 may control some or all of these vehicle systems 140.

The processor(s) 110, and/or the automated driving module(s) 160 may be operable to control the navigation and/or maneuvering of the vehicle 100 by controlling one or more of the vehicle systems 140 and/or components thereof. For instance, when operating in an autonomous mode, the processor(s) 110, and/or the automated driving module(s) 160 can control the direction and/or speed of the vehicle 100. The processor(s) 110, and/or the automated driving module(s) 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the automated driving module(s) 160. Any suitable actuator can be used. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine the position and velocity of the vehicle 100. The automated driving module(s) 160 can determine the location of obstacles, obstacles, or other environmental features, including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the action system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An action system, comprising:
one or more processors; and
a memory communicably coupled to the one or more processors and storing:
a control module including instructions that, when executed by the one or more processors, cause the one or more processors to:
acquire data about a route and a current location of a vehicle;
predict a path of the vehicle according to the data;
responsive to determining the path satisfies an action threshold, generate a message about the path; and
communicate the message to a target area.

2. The action system of claim 1, wherein the control module includes instructions to acquire the data including instructions to determine a current route of the vehicle and a current location of the vehicle that specifies a lane of a road on which the vehicle is traveling, and
wherein the data includes one or more of GPS data, LiDAR data, radar data, ultrasonic data, map data, and camera image data.

3. The action system of claim 2, wherein the control module includes instructions to determine the route including instructions to perform one of: inferring the route according to learned behaviors of a driver of the vehicle, or identifying an explicit destination and route plan that the driver is following, and
wherein the control module includes instructions to infer the route including instructions to identify patterns of the driver according to prior routes driven by the driver.

4. The action system of claim 1, wherein the control module includes instructions to predict the path including instructions to determine a future maneuver of the vehicle that is associated with the route of the vehicle, wherein the future maneuver being a nominal maneuver or an unexpected maneuver, and
wherein the message identifies the vehicle and the future maneuver.

5. The action system of claim 4, wherein the control module includes instructions to determine the path satisfies the action threshold including instructions to determine whether the potential future maneuver involves at least one of: a sudden input to control the vehicle to correct the vehicle being out of position for the route, an abrupt alteration of speed, and an abrupt turn of the vehicle.

6. The action system of claim 4, wherein the control module includes instructions to determine the path satisfies the action threshold including instructions to determine that the future maneuver is likely to influence operation of at least one nearby vehicle.

7. The action system of claim 1, wherein the control module includes instructions to:
determine the target area associated with the path including identifying a region proximate to the vehicle that would be affected by the path of the vehicle and likely includes at least one nearby vehicle.

8. The action system of claim 1, wherein the control module includes instructions to communicate the message to the target area including instructions to control a transceiver to focus transmission of the message in the target area to alert a nearby vehicle about the vehicle following the path, and
wherein the control module includes instructions to communicate the message to the target area including instructions to communicate the message without knowledge of a presence of any vehicles in the target area.

9. A non-transitory computer-readable medium storing instructions that, when executed by one or more processors, cause the one or more processors to:
acquire data about a route and a current location of a vehicle;
predict a path of the vehicle according to the data;
responsive to determining the path satisfies an action threshold, generate a message about the path; and
communicate the message to a target area.

10. The non-transitory computer-readable medium of claim 9, wherein the instructions to acquire the data including instructions to determine a current route of the vehicle and a current location of the vehicle that specifies a lane of a road on which the vehicle is traveling, and
wherein the data includes one or more of GPS data, and image data.

11. The non-transitory computer-readable medium of claim 9, wherein the instructions to predict the path including instructions to determine a future maneuver of the vehicle that is associated with the route of the vehicle, wherein the future maneuver being a nominal maneuver or an unexpected maneuver, and
wherein the message identifies the vehicle and the future maneuver.

12. The non-transitory computer-readable medium of claim 11, wherein the instructions to determine the path satisfies the action threshold include instructions to determine whether the potential future maneuver involves at least one of: a sudden input to control the vehicle to correct the vehicle being out of position for the route, an abrupt alteration of speed, and an abrupt turn of the vehicle.

13. The non-transitory computer-readable medium of claim 9, wherein the instructions further include instructions to determine the target area associated with the path including identifying a region proximate to the vehicle that would be affected by the path of the vehicle and likely includes at least one nearby vehicle.

14. A method, comprising:
acquiring data about a route and a current location of a vehicle;
predicting a path of the vehicle according to the data;
responsive to determining the path satisfies an action threshold, generating a message about the path; and
communicating the message to a target area.

15. The method of claim 14, wherein acquiring the data includes determining a current route of the vehicle and a current location of the vehicle that specifies a lane of a road on which the vehicle is traveling, and
wherein the data includes one or more of GPS data, and image data.

16. The method of claim 15, wherein determining the route includes one of: inferring the route according to learned behaviors of a driver of the vehicle, or identifying an explicit destination and route plan that the driver is following, and
wherein inferring the route includes identifying patterns of the driver according to prior routes driven by the driver.

17. The method of claim 14, wherein predicting the path includes determining a future maneuver of the vehicle that is associated with the route of the vehicle, wherein the future maneuver being a nominal maneuver or an unexpected maneuver, and
wherein the message identifies the vehicle and the future maneuver.

18. The method of claim 17, wherein determining the path satisfies the action threshold includes determining whether the future maneuver involves at least one of: a sudden input to control the vehicle to correct the vehicle being out of position for the route, an abrupt alteration of speed, and an abrupt turn of the vehicle, and
wherein determining the path satisfies the action threshold includes determining that the future maneuver is likely to influence operation of at least one nearby vehicle.

19. The method of claim 14, further comprising:
determining the target area associated with the path including identifying a region proximate to the vehicle that would be affected by the path of the vehicle and likely includes at least one nearby vehicle.

20. The method of claim 14, wherein communicating the message to the target area includes controlling a transceiver to focus transmission of the message in the target area to alert a nearby vehicle about the vehicle following the path, and
wherein communicating the message to the target area includes communicating the message without knowledge of a presence of any vehicles in the target area.
